(19) United States
(12) Patent Application Publication
(10) Pub. No.: US 2025/0333100 A1
(43) Pub. Date: Oct. 30, 2025

(54) VEHICEL CONTROL METHOD AND DEVICE

(71) Applicant: HL MANDO CORPORATION, Gyeonggi-do (KR)

(72) Inventor: Jae Woo LEE, Gyeonggi-do (KR)

(21) Appl. No.: 19/053,412

(22) Filed: Feb. 13, 2025

(30) Foreign Application Priority Data
Apr. 30, 2024 (KR) 10-2024-0057958

(51) Int. Cl. B62D 6/00; B62D 15/02

(52) U.S. Cl. CPC B62D 6/00; B62D 15/0225

(57) ABSTRACT

The present embodiments relate to a vehicle control method and device capable of receiving sensed information generated by one or more sensors, determining a mode change intention of a driver for changing a mode for driving a vehicle based on the sensed information of the one or more sensors, setting a rack position control value for controlling a rack position using the sensed information of the one or more sensors in response to the mode change intention of the driver, determining a control limit value by comparing a difference between the rack position control value set using the sensed information and a rack position value expected in the changed mode with a threshold value, and changing the rack position control value based on the control limit value.

### CROSS REFERENCE TO RELATED APPLICATION

This application claims priority from Korean Patent Application No. 10-2024-0057958, filed on Apr. 30, 2024, which is hereby incorporated by reference for all purposes as if fully set forth herein.

### TECHNICAL FIELD

An embodiment of the present disclosure relates to a vehicle control method and device.

### BACKGROUND

When changing driving modes, for example, when switching between a sports mode and a comfort mode, the change in steering feeling may be compensated, but the vehicle behavior may change suddenly due to a sudden change in a rack position control value. In order to solve this problem, there is required a technology for smooth transition or switching between the driving modes.

In a general electric power steering technology, there may be performed the change of a driving mode of a vehicle in a timing when a torsion bar torque passed 0 Nm. However, in a vehicle equipped with a steer-by-wire (SbW) system, even when the torsion bar torque is 0 Nm, there may be occurred a large change in a rack position control value when changing the driving mode due to a variable gear ratio (VGR). This may cause a sudden change in the vehicle behavior. In addition, there is a problem of providing a feeling of discomfort to a driver of a vehicle.

However, there is insufficient a method to solve the problem that may occur when changing the driving mode of a vehicle equipped with an SBW system.

### SUMMARY

Embodiments of the present disclosure are to provide a vehicle control method and device capable of reducing a feeling of discomfort when changing or switching the driving mode of a vehicle.

In accordance with an aspect of the present disclosure, there may be provided a vehicle control method including receiving sensed information generated by one or more sensors, determining a mode change intention of a driver for changing a mode for driving a vehicle based on the sensed information of the one or more sensors, setting a rack position control value for controlling a rack position using the sensed information of the one or more sensors in response to the mode change intention of the driver, determining a control limit value by comparing a difference between the rack position control value set using the sensed information and a rack position value expected in the changed mode with a threshold value, and changing the rack position control value based on the control limit value.

In accordance with another aspect of the present disclosure, there may be provided a vehicle control device including a memory configured to store instructions that are executable and one or more processors configured to execute the instructions to perform operations comprising: receiving sensed information generated by one or more sensors, determining a mode change intention of a driver for changing a mode for driving a vehicle based on the sensed information of the one or more sensors, setting a rack position control value for controlling a rack position using the sensed information of the one or more sensors in response to the mode change intention of the driver, determining a control limit value by comparing a difference between the rack position control value set using the sensed information and a rack position value expected in the changed mode with a threshold value, and changing the rack position control value based on the control limit value.

According to an embodiment of the present disclosure, it is possible to provide a vehicle control method and device capable of reducing a feeling of discomfort when changing or switching the driving mode of a vehicle.

### BRIEF DESCRIPTION OF THE DRAWINGS

FIG. 1 is a flowchart for explaining a vehicle control method according to an embodiment.

FIG. 2 is a flowchart for explaining an operation for determining a mode change intention according to one embodiment.

FIG. 3 is a diagram for explaining an operation for determining a control limit value according to one embodiment.

FIG. 4 is a diagram for explaining a vehicle control method not including a position setting step according to one embodiment.

FIG. 5 illustrates an example of a control limit value, a first control limit value, and a second control limit value according to one embodiment.

FIG. 6 illustrates a vehicle control device according to one embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described an embodiment of a steering control system capable of performing a vehicle control method and, in particular, performing a function of controlling steering of a vehicle.

A steering control system according to one embodiment may include a vehicle control device, a steering feedback actuator (SFA), and a road wheel actuator (RWA).

A steering according control system to one embodiment may mean a system which controls the steering of a vehicle equipped with a steering control system to change according to a rotation angle of a steering wheel operated by a driver.

Depending on whether a steering input actuator and a steering output actuator are connected by a mechanical linkage, a steering control system may be a mechanical steering control system in which the driver rotates the steering wheel and the force (e.g., torque) generated is transmitted to a steering motor through a mechanical power transmission device (e.g., linkage, etc.), or may be a steer-by-wire (SbW) system in which power is transmitted by transmitting and receiving electrical signals through wires or cables instead of a mechanical power transmission device. Hereinafter, it will be described a steering control system based on the SbW system, but is not limited thereto.

The steering control system according to the present disclosure may implement the SbW system with the SFA, the vehicle control device, and the RWA. As described above, in the case that the steering control system is the SbW system, the SFA and the RWA may be mechanically separated.

The SFA may mean a device that inputs sensed information intended by the driver. Such SFA may include, as described above, a steering wheel, a steering shaft, and a reaction motor. In addition, the SFA may further include a steering gear transmitting a rotational force of the reaction motor to the steering shaft. In addition, a torsion bar disposed between an input shaft and an output shaft of the steering shaft may be further included. In this case, steering torque information described later may mean sensed information generated through the torsion bar.

The SFA may include a steering angle sensor for detecting a steering angle of the steering wheel, a torque sensor for detecting a steering torque of the driver, a steering angular velocity sensor for detecting a steering angular velocity of the steering wheel, and a torsion bar torque sensor for detecting a torsion bar torque of the torsion bar.

The vehicle control device may receive input values from each sensor included in the SFA, generate sensed information, and output an electrical signal indicating the sensed information to the RWA. Here, the sensed information may mean information including steering torque information.

Meanwhile, the vehicle control device may receive feedback on the power information (e.g., rack position information) actually output from the RWA, determine a second control value, and output an electric signal indicating the second control value to the SFA, thereby providing a steering feeling to the driver.

The RWA may mean a device which drives a vehicle to actually steer. The RWA may include a steering motor, a rack, a front wheel, a vehicle speed sensor, a rack position sensor, etc. Here, the front wheel may be configured as a rear wheel instead depending on the driving method of the vehicle.

In addition, the SFA and the RWA may further include a motor torque sensor capable of detecting a motor torque of the reaction motor and the steering motor.

The steering control system may further include a mechanical switching means such as a clutch capable of separating or connecting the SEA and RWA. Here, the clutch may be operated under the control of the vehicle control device.

Meanwhile, in the case that the steering control system is a SbW system and the vehicle is driven in an autonomous driving mode, the steering control system may perform steering control of the vehicle by controlling only the RWA, or may perform steering control of the vehicle by controlling both the SFA and RWA.

In one embodiment, the vehicle control device may be a type of an advance driver assistance system (ADAS) which provides information to assist driving of the vehicle or assists the driver in controlling the vehicle.

Here, ADAS may mean various types of advanced driver assistance systems, and driver assistance systems may include, for example, An autonomous Emergency Braking (AEB) system, a Smart Parking Assistance System (SPAS), a Blind Spot Detection (BSD) system, an Adaptive Cruise Control (ACC) system, a Lane Departure Warning System (LDWS), a Lane Keeping Assist System (LKAS), a Lane Change Assist System (LCAS), etc. However, the present disclosure is not limited thereto.

Hereinafter, it will be described a vehicle control method and a vehicle control device according to an embodiment of the present disclosure with reference to the attached drawings.

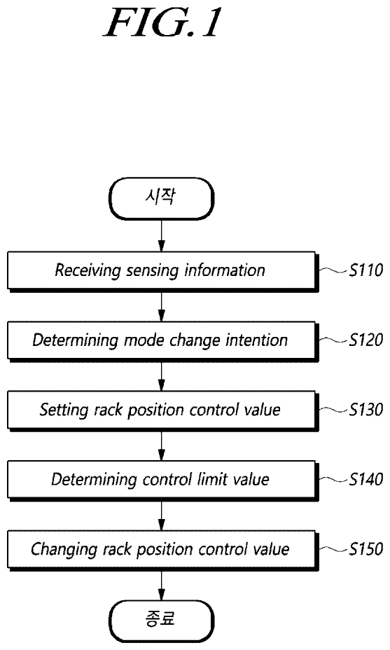

FIG. 1 is a flowchart for explaining a vehicle control method according to an embodiment.

Referring to FIG. 1, in a vehicle control method of a vehicle equipped with an SBW system, the vehicle control method may include a sensed information receiving step (S110) for receiving sensed information generated by one or more sensors, a mode change intention determination step (S120) for determining a mode change intention of a driver for changing a mode for driving a vehicle based on the sensed information of the one or more sensors, a position setting step (S130) for setting a rack position control value for controlling a rack position using the sensed information of the one or more sensors if it is determined that there is the mode change intention of the driver, a control limit value determination step (S140) for comparing a difference between the rack position control value set using the sensed information and the expected rack position value in the changed mode with a preset threshold value and determining a control limit value, and a change step (S150) for changing the rack position control value according to the control limit value.

Hereinafter, the vehicle control method will be described for a vehicle equipped with an SBW system as an example.

In the sensed information receiving step, there may be received sensed information generated by one or more sensors. (S110)

For example, one or more sensors may include a sensor capable of generating sensed information of SFA and RWA of the vehicle. In addition, one or more sensors may include a sensor capable of utilizing CAN communication for generating a mode change signal. Since the sensor capable of generating sensed information of SFA and RWA has been described above, hereinafter, it will be described a sensor capable of generating a mode change signal.

As an example, the sensor may include a mode change sensor capable of generating a mode change signal. The mode change sensor may be provided in a cluster forming a driver's seat. In addition, the mode change sensor may be provided in the form of a button in the cluster or in the form of a touch screen. Without being limited to the present embodiment, the mode change sensor may be provided in the vehicle in various forms.

For example, the sensed information may include at least one of a mode change signal for changing the mode for driving the vehicle, information related to a steering torque (steering torque information), and information related to a rack position (rack position information).

For example, the mode may include a comfort mode and a sports mode, etc. In addition, the mode may be divided into a comfort mode and a sports mode according to an expected rack position value. For example, an expected rack position value of the comfort mode may be formed relatively smaller than an expected rack position value of the sports mode. In addition, the expected rack position value may be set in various ways depending on the type of the vehicle. In addition, the mode is not limited to the types of the modes described above and may exist in various types. Hereinafter, for convenience of explanation, it will be described a case using the comfort mode and the sports mode.

For example, the mode change signal may mean sensed information generated by the driver manipulating the mode change sensor. For example, the mode may be changed from the comfort mode to the sports mode according to the mode change signal. In addition, the mode may be changed from the sports mode to the comfort mode according to the mode change signal.

For example, the steering torque information may mean sensed information generated through the torsion bar. The torsion bar torque sensor may detect the torsion bar torque of the torsion bar. In this case, the torsion bar torque may be generated from the steering torque information. However, it is not limited to this embodiment, and the steering torque information may be generated in various ways.

For example, the rack position information may mean sensed information generated by receiving a current position value of a rack connected to the RWA by a rack position sensor. For example, if a rack position control value is determined through a vehicle control method, the position of the rack of the RWA may be changed according to the determined rack position control value. In this case, the changed position value of the rack may be included in the rack position information. Therefore, the rack position information may be information which follows the rack position control value. However, it is not limited to the present embodiment, and the rack position information may be generated in various ways.

The mode change intention determination step may determine a mode change intention of the driver for changing a mode for driving a vehicle based on the sensed information of the one or more sensors. (S120)

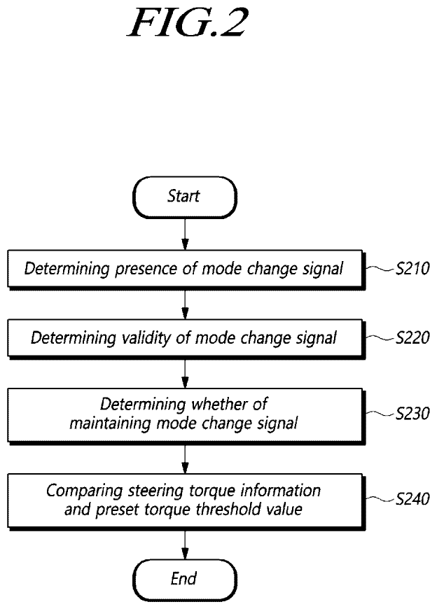

FIG. 2 is a flowchart for explaining an operation for determining a mode change intention according to one embodiment.

Referring to FIG. 2, in the mode change intention determination steps, the mode change intention of the driver may be determined based on the mode change signal and the steering torque information. For example, the mode change intention determination step may include determining whether the mode change signal exists (S210), determining whether the mode change signal is valid (S220), determining whether the mode change signal is maintained (S230), and determining the mode change intention by comparing the steering torque information with a preset threshold value. (S240)

For example, the mode change intention determination step may include determining that there is a mode change intention of the driver if the mode change signal is valid and the steering torque information is smaller than or equal to a preset threshold value. Another example, the mode change intention detection step may include determining that there is a mode change intention of the driver if a valid mode change signal is maintained for a specific period of time and the steering torque information is smaller than or equal to a preset threshold value. The specific period of time is preset time period. For example, the specific period of time set X second, the X is a natural number.

For example, the mode change intention determination step may include determining whether of presence of the mode change signal (S210). In this case, the presence of the mode change signal may be determined using whether the mode change signal has been received.

However, the method for determining whether the mode change signal exists is not limited to the present embodiment, and may be set in various ways.

For example, if it is determined that there is no mode change signal, which may be determined that the driver has no intention to change the mode.

Alternatively, if it is determined that there is a mode change signal, the mode change intention determination step may include determining whether the mode change signal is valid. (S220) In this case, the validity of the mode change signal may be determined by using whether the mode change signal has been received through the mode change sensor or through another sensor.

However, the method for determining the validity of the mode change signal is not limited to the present embodiment, and may be implemented in various ways.

For example, if the mode change signal is determined to be invalid, it may be determined that the driver has no intention to change the mode.

On the other hand, if the mode change signal is determined to be valid, the mode change intention determination step may include determining whether the mode change signal is maintained. (S230) In this case, whether the mode change signal is maintained may be determined by using whether the mode change signal exists continuously for a specific period of time through the mode change sensor. The specific period of time may be set to A seconds (where A is a real number greater than 0).

However, the method for determining whether of maintaining of the mode change signal is not limited to the present embodiment, and may be implemented in various ways.

For example, if the mode change signal is determined to be not maintained, it may be determined that the driver has no intention to change the mode.

On the other hand, if the mode change signal is determined to be maintained for specific period of time, the mode change intention determination step may include comparing the steering torque information and a preset torque threshold value (S240).

For example, the preset torque threshold value may mean a value determined using the torsion bar torque value stored while the vehicle is driving. For example, the preset torque threshold value may mean K Nm (where K is a real number greater than or equal to 0). However, the preset torque threshold value may be set variously depending on the vehicle, and may be set differently depending on the mode. Hereinafter, the preset torque threshold value will be explained using the definition described above.

For example, if it is determined that the steering torque information exceeds the preset torque threshold value, it may be determined that the driver has no intention to change the mode.

For another example, if it is determined that the steering torque information is less than or equal to the preset torque threshold value, it may be determined that the driver has an intention to change the mode.

For another example, if the product of the steering torque information and the preset torque threshold value is less than 0 in addition to the comparison of the steering torque information and the preset torque threshold value, there may be determined that the driver has an intention to change the mode. In this case, the fact that the product of the steering torque information and the preset torque threshold value is less than 0 may mean that the sign has changed and passed a zero point. In addition, the preset torque threshold value may mean a value determined using the torsion bar torque value stored while the vehicle was driven in the past, as described above.

In addition, the operation of comparing the steering torque information and the preset torque threshold value is not limited to this embodiment, and may be implemented in various ways.

For another example, the mode change intention determination step may include determining that there is the mode change intention if it is determined that a mode change signal exists, the mode change signal is determined to be valid, the mode change signal is determined to be maintained for a specific period of time, and the steering torque information is smaller than or equal to a preset torque threshold value.

However, the present embodiment is not limited thereto, and the mode change intention may be determined in various ways using various sensed information.

The position setting step may include setting a rack position control value using sensed information if it is determined that there is the mode change intention. (S130)

The rack position control value may mean a value determined to control a position of a rack of the RWA. Therefore, if the rack position control value is determined, the position of the rack may be adjusted according to the rack position control value.

For example, the position setting step may include setting the rack position information included in the sensed information as the rack position control value.

The rack position control value may be a value determined to control the position of the rack. Therefore, the position of the rack may be required to follow the rack position control value. In addition, the rack position control value, in principle, may follow the expected rack position value in the changed mode as a target.

For example, when the vehicle mode is changed, the rack position control value may also change significantly. Accordingly, the position of the rack in the RWA may change rapidly. If the position of the rack changes rapidly, there may be caused a feeling of discomfort or a sense of incongruity to the driver, and a large motor torque may be generated, thereby causing noise. To prevent this situation, the rack position control value is required to be reset or set to a specific value if the vehicle mode is changed.

Therefore, the position setting step may include setting the rack position control value using the rack position information instead of immediately following the expected rack position value when the mode is changed. That is, the position setting step may include setting the rack position information including the current position value of the rack as the rack position control value. Accordingly, there may be reduced the feeling of discomfort of the driver in driving, and the noise phenomenon may be reduced.

However, the rack position control value may be set using various sensed information without being limited to the present embodiment as above.

The control limit value determination step may include comparing a difference between the rack position control value and the expected rack position value in the changed mode with a preset threshold value, and determining a control limit value. (S140)

The preset threshold value may be a value set to determine whether the difference between the rack position control value and the expected rack position value in the changed mode is sufficiently small. In the subsequent changing step, if it is determined that the difference is sufficiently small, the rack position control value may be set to the expected rack position value in the changed mode. Accordingly, the position of the rack of the RWA controlled by the rack position control value may not change significantly. Therefore, there may be reduced the feeling of discomfort of the driver.

For example, the preset threshold value may be set to N mm (where N is a real number greater than 0). Here, N can be set in advance in various ways depending on the vehicle. However, the preset threshold value is not limited to this embodiment, and may be set in advance in various ways.

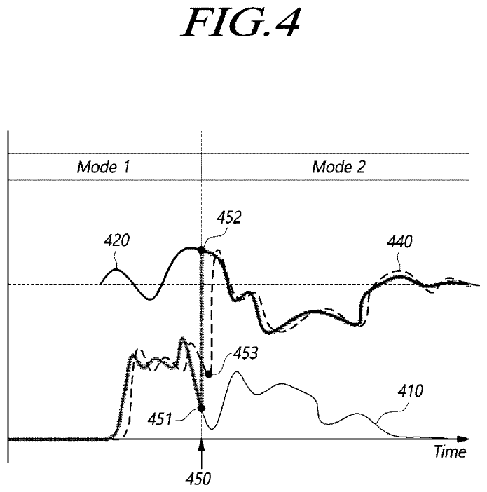

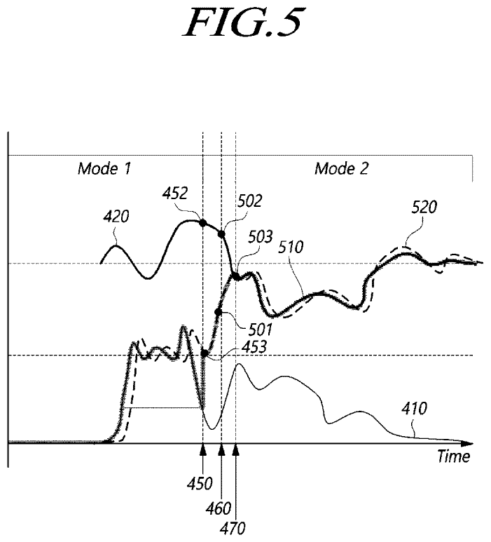

For another example, the control limit value may be a value determined so that the rack position control value can quickly approach the expected rack position value in the changed mode. The definition of the control limit value will be described later with reference to FIGS. 4 and 5.

In addition, the control limit value may be determined as one of a first control limit value and a second control limit value. For example, the first control limit value may be set to 250 mm/s to 300 mm/s. In this case, the second control limit value may be set to a lower value than the first control limit value. However, the first control limit value and the second control limit may be set differently depending on the vehicle, and may be set differently depending on a speed of the vehicle. In addition, the control limit value is not limited to the present embodiment, and may be set to various values.

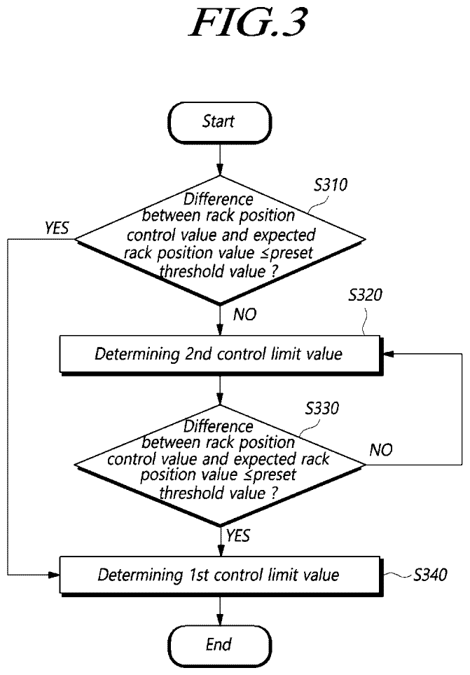

Hereinafter, it will be described a specific operation for determining the control limit value with reference to FIG. 3.

FIG. 3 is a diagram for explaining an operation for determining a control limit value according to one embodiment.

Referring to FIG. 3, the control limit value determination step may include comparing the difference between the rack position control value set using the sensed information and the rack position value expected in the changed mode with a preset threshold value. (S310)

For example, the control limit value determination step may include determining the control limit value as a first control limit value if the difference between the rack position control value set using the sensed information and the rack position value expected in the changed mode is smaller than or equal to the preset threshold value. (S340)

Alternatively, the control limit value determination step may include determining of the control limit value as a second control limit value different from the first control limit value if the difference between the rack position control value set using the sensed information and the rack position value expected in the changed mode is greater than the preset threshold value, and the change step may include changing the rack position control value according to the second control limit value. (S320) The second control limit value is lower than the first control limit value.

In addition, the control limit value determination step may further include a re-determining step of re-determining a difference between the rack position control value set using the sensed information and the rack position value expected in the changed mode (S330), comparing the re-determined difference between the rack position control value set using the sensed information and the rack position value expected in the changed mode with a preset threshold value, and re-determining the control limit value.

In this case, the control limit value may be determined as either the first control limit value or the second control limit value depending on the result of re-determining the difference.

However, the present embodiment is not limited, and steps S310 to S340 may be combined in various ways. In addition, there may be possible a combination which terminates with step S340 depending on the determination result of step S330.

In addition, a detailed description of the first control limit value and the second control limit value will be described later with reference to FIGS. 4 and 5.

The change step may include changing the rack position control value according to the control limit value. (S150)

For example, the change step may include setting the expected rack position value as the rack position control value according to the control limit value. A detailed description of the present embodiment will be described later with reference to FIGS. 4 and 5.

FIG. 4 is a diagram for explaining a vehicle control method not including a position setting step according to one embodiment. FIG. 5 illustrates an example of a control limit value, a first control limit value, and a second control limit value according to one embodiment.

A horizontal axis of FIGS. 4 and 5 is set to a time (unit: ms, s, etc.), and a vertical axis is set to a position (unit: mm, cm, m, etc.).

The expected rack position value may include a first expected value 410 and a second expected value 420. The rack position control value 430 may follow the first expected value 410 or the second expected value 420 depending on the mode. In addition, the rack position information 440 may mean a position value of a rack of an actual RWA controlled according to the rack position control value 430. Referring to FIGS. 4 and 5, the rack position information 440 may follow the rack position control value (430).

Referring to FIG. 4, there are illustrated a timing or a first time point 450 when the mode changes from a Mode 1 to a Mode 2. A first expected rack position value 451 may mean an expected rack position value of the first expected value 410 when the Mode 1 ends. A second expected rack position value 452 may mean an expected rack position value of the second expected value 420 when Mode 2 starts. A rack position information 453 at the first time point exists on the rack position information 440.

In this case, if the mode is changed from the Mode 1 to the Mode 2, the rack position control value may change from the first expected rack position value 451 to the second expected rack position value 452. In this case, the actual position of the rack in the RWA may change significantly due to a sudden change in the rack position control value. Accordingly, the driver may greatly feel a discomfort.

Therefore, in the position setting step, if the rack position information 453 of the first time point included in the sensed information may be set as the first rack position control value from the first expected rack position value 451, thereby reducing the feeling of discomfort of the driver.

Referring to FIG. 5, there is illustrated a case of a vehicle control method including the position setting step. There are indicated a rack position control value 510 and a rack position information 520 following the rack position control value. In the position setting step, the rack position information 453 of the first time point may be set as the first rack position control value. Hereinafter, for the convenience of explanation, the first rack position control value and the rack position information 453 of the first time point may be defined identically and interchangeably used.

In this case, the control limit value determination step may include determining a difference between the first rack position control value 453 and the second expected rack position value 452. In addition, the control limit value determination step may include determining the control limit value by comparing the difference with a preset threshold value.

In this case, the control limit value may mean the change in position from a specific time point t1 to another specific time point t2. In addition, the control limit value may be selected as one of a first control limit value and a second limit value. Accordingly, the first control limit value and the second control limit value may also mean the change in position from a specific time point t1 to another specific time point t2, and the values may include the numerical values described above. In addition, the specific points in time t1 and t2 may be set to various points in time without limitation.

For example, in the present embodiment, the second control limit value may be set to the change in position from the first time point 450 to a second time point 460. In addition, the first control limit value may be set to the change in position from the second time point 460 to a third time point 470. However, the control limit value is not limited thereto, and may be set to the change in position at various points in time.

For example, the control limit value determination step may include comparing the difference with a preset threshold value, and if the difference is greater than or exceeds the preset threshold value, the control limit value may be set to the second control limit value. In this case, the change step may include changing the rack position control value from the first rack position control value 453 to the second rack position control value 501 at the second time point 460 according to the second control limit value.

In addition, the control limit value determination step may further include re-determining the difference between the second rack position control value 501 and an expected rack position value 502 at the second time point 460. In addition, the control limit value determination step may include comparing the re-determined difference with the preset threshold value again, and determining the control limit value.

For example, if the difference is less than or equal to the preset threshold value, the change step may include changing the second rack position control value 501 to a third rack position control value 503 at the third time point 470 according to the first control limit value. In addition, the third rack position control value 503 of FIG. 5 may have an intersection point with the second expected value 420. That is, there may be determined that the third rack position control value 503 is almost the same as an expected rack position value in the third point of time 470 with little difference. Therefore, there may be considered that the rack position control value is set to the expected rack position value of the third point of time 470 according to the first control limit value.

On the other hand, if the difference exceeds the preset threshold value, the change step may include changing the rack position control value again according to the second control limit value. In addition, the control limit value determination step and the change step may be repeatedly performed depending on the case.

As another example, the control limit value determination step may include comparing the difference with the preset threshold value, and setting the control limit value to the first control limit value if the difference is less than or equal to the preset threshold value. In this case, the change step may include changing the time point according to the first control limit value, and setting the rack position control value to one of the second expected values 420 at the changed time point.

However, the present disclosure is not limited to this embodiment, and there may be set various control limit values, first control limit values, and second control limit values.

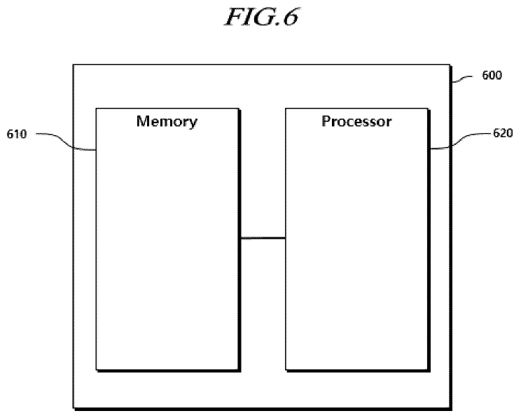

FIG. 6 illustrates a vehicle control device according to one embodiment.

Referring to FIG. 6, as a vehicle control device 600 of a vehicle equipped with an SBW system, the vehicle control device 600 may include a memory 610 configured to store instructions that are executable and one or more processors 620 configured to execute the instructions to perform operations comprising receiving sensed information generated by one or more sensors, determining a mode change intention of a driver for changing a mode for driving a vehicle based on the sensed information of the one or more sensors, setting a rack position control value for controlling a rack position using the sensed information of the one or more sensors in response to the mode change intention of the driver, determining a control limit value by comparing a difference between the rack position control value set using the sensed information and a rack position value expected in the changed mode with a threshold value, and changing the rack position control value based on the control limit value. Hereinafter, the vehicle control device 600 will be described with a focus on a vehicle equipped with an SBW system.

The one or more processors 620 may receive sensed information generated by one or more sensors.

For example, one or more sensors may include sensors capable of generating sensed information in the SEA and RWA of the vehicle. In addition, one or more sensors may refer to sensors capable of utilizing CAN communication for generating a mode change signal.

As an example, the sensor may include a mode change sensor capable of generating a mode change signal for changing the mode for driving the vehicle. The mode change sensor may be provided in a cluster forming a driver's seat. In addition, the mode change sensor may be mounted in the cluster in the form of a button or in the form of a touch screen. The mode change sensor may be mounted in the vehicle in various forms without being limited to the present embodiment.

For example, the sensed information may include at least one of a mode change signal for changing the mode for driving the vehicle, information related to a steering torque (steering torque information), and information related to a rack position (rack position information).

For example, the mode may include a comfort mode and a sports mode. In addition, the mode may be divided into the comfort mode and the sports mode depending on the expected rack position value. For example, an expected rack position value of the comfort mode may be relatively smaller than an expected rack position value of the sports mode. In addition, the expected rack position value may be set variously depending on the type of vehicle. In addition, the mode is not limited to the present embodiment, and may include or may be defined various modes.

For example, the mode change signal may mean sensed information generated by the driver manipulating the mode change sensor. Depending on the mode change signal, the mode may be changed or switched to another mode. For example, depending on the mode change signal, the mode may be changed from the comfort mode to the sports mode. In addition, depending on the mode change signal, the mode may be changed from the sports mode to the comfort mode.

For example, the steering torque information may mean sensed information generated through a torsion bar. The torsion bar torque sensor may detect a torsion bar torque of the torsion bar. In this case, the torsion bar torque may be generated as steering torque information. However, the present disclosure is not limited to this embodiment, and steering torque information may be generated in various ways.

For example, the rack position information may mean sensed information generated by receiving a current position of a rack connected to the RWA by a rack position sensor. For example, if a rack position control value is determined through a vehicle control device 600, the position of the rack of the RWA may be changed according to the determined rack position control value. The changed position value of the rack may be included in the rack position information. Therefore, the rack position information may be information following the rack position control value.

However, the rack position information is not limited to the present embodiment, and the rack position information may be generated in various ways.

The one or more processors 620 may determine the mode change intention of the driver based on the sensed information.

For example, the one or more processors 620 may determine whether there is the mode change intention based on a mode change signal and steering torque information.

The one or more processors 620 may determine whether a mode change signal exists, determine whether the mode change signal is valid, determine whether the mode change signal is maintained for a specific period of time, and compare steering torque information with a preset torque threshold value to determine the presence of the mode change intention.

For example, the one or more processors 620 may determine that there is the mode change intention if a valid mode change signal is maintained for a specific period of time and the steering torque information is below a preset torque threshold value.

For example, the one or more processors 620 may determine whether a mode change signal exists. In this case, the existence of a mode change signal may be determined by using whether a mode change signal has been received.

However, the method for determining the existence of a mode change signal is not limited to this embodiment, and may be implemented in various ways.

For example, if it is determined that there is no mode change signal, the one or more processors 620 may determine that the driver does not have an intention to change the mode.

However, if it is determined that there is a mode change signal, the mode change intention determiner may determine whether the mode change signal is valid. In this case, the validity of the mode change signal may be determined by using whether the mode change signal has been received through a mode change sensor or through another sensor.

However, the method for determining the validity of the mode change signal is not limited to this embodiment, and may be implemented in various ways.

For example, if the mode change signal is determined to be invalid, the mode change intention determiner may determine that the driver has no intention to change the mode.

However, if the mode change signal is determined to be valid, the mode change intention determiner may determine whether the mode change signal is maintained. In this case, whether of maintaining of the mode change signal may be determined by using whether the mode change signal exists continuously for a specific period of time through the mode change sensor.

However, the method for determining whether the mode change signal is maintained may be not limited to this embodiment, and may be implemented in various ways.

For example, if the mode change signal is determined to be not maintained, the mode change intention determiner may determine that the driver has no intention to change the mode.

However, if it is determined that the mode change signal is maintained, the mode change intention determiner may compare the steering torque information and the preset torque threshold value.

For example, the preset torque threshold value may mean a value determined using the torsion bar torque stored by the driver while driving the vehicle. For example, the preset torque threshold value may mean K Nm (where K is a real number greater than or equal to 0). However, the preset threshold value may be set variously depending on the vehicle and may be set differently depending on the mode. Hereinafter, the preset torque threshold value will be explained using the definition described above.

For another example, if it is determined that the steering torque information is greater than the preset torque threshold value, the mode change intention determiner may determine that the driver has no intention to change the mode. However, if it is determined that the steering torque information is less than the preset torque threshold value, the mode change intention determiner may determine that the driver has an intention to change the mode.

For another example, if the steering torque information is compared with a preset torque threshold value, and the product of the steering torque information and the preset torque threshold value is less than 0, the mode change intention determiner may determine that the driver has an intention to change the mode.

However, the operation of comparing the steering torque information with the preset torque threshold value is not limited to this embodiment, and may be implemented in various ways.

For another example, the one or more processors 620 may determine that there is the mode change intention if it is determined that a mode change signal exists, the mode change signal is determined to be valid, the mode change signal is determined to be maintained for a specific period of time, and the steering torque information is smaller than or equal to a preset torque threshold value.

However, the determination of the mode change intention is not limited to this embodiment, and may be implemented using various sensed information.

If it is determined that there is the mode change intention, the one or more processors 620 may set a rack position control value using the sensed information.

The rack position control value may mean a value determined to control a position of a rack of the RWA. Therefore, when the rack position control value is determined, the position of the rack may be adjusted according to the rack position control value.

For example, the one or more processors 620 may set the rack position information included in the sensed information as the rack position control value.

The rack position control value may be a value determined to control the position of the rack. Therefore, the position of the rack should follow the rack position control value. In addition, the rack position control value may follow the expected position value in the corresponding mode as a target.

Therefore, when the vehicle mode is changed, the position of the RWA rack may change rapidly. In addition, the rack position control value may also change significantly. In this case, if the actual position of the rack changes rapidly, there may cause a feeling of discomfort or a sense of incongruity to the driver, and a large motor torque may be generated, thereby causing noise. In order to prevent this problem, the rack position control value is required to be reset or set to a specific value when the vehicle mode is changed.

Therefore, the one or more processors 620 may set the rack position control value using the rack position information instead of immediately following the expected rack position value when the mode is changed. That is, the position setter may set the rack position information including the current position of the rack as the rack position control value.

However, the rack position control value may be set using various sensed information without being limited to the present embodiment.

The one or more processors 620 may compare the difference between the rack position control value and the expected rack position value in the changed mode with a preset threshold value, and may determine the control limit value.

For example, the preset threshold value may be a value set to determine whether the difference between the rack position control value and the expected rack position value in the changed mode is sufficiently small. For example, the preset threshold value may be set to N mm (where N is a real number greater than or equal to 0). Here, N may be variously set in advance depending on the vehicle. However, the preset threshold value is not limited to the present embodiment and may be variously set in advance.

For another example, the control limit value may be a value determined so that the rack position control value may quickly approach the expected rack position value in the changed mode.

In addition, the control limit value may be determined as one of a first control limit value and a second control limit value. For example, the first control limit value may be set to 250 mm/s to 300 mm/s. In this case, the second control limit value may be set to a lower value than the first control limit value. However, the first control limit value and the second control limit value may be set differently depending on the vehicle, or may be set differently depending on the speed of the vehicle. In addition, the first control limit value and the second control limit value may be set in various ways without being limited to the present embodiment.

The one or more processors 620 may compare the difference between the rack position control value and the expected rack position value in the changed mode with a preset threshold value.

For example, the one or more processors 620 may determine the control limit value as the first control limit value if the difference is less than or equal to the preset threshold value.

On the other hand, the one or more processors 620 may determine the control limit value as the second control limit value if the difference is greater than the preset threshold value, and the changer may change the rack position control value according to the second control limit value.

In addition, the one or more processors 620 may further include a re-determine which re-determines the difference between the rack position control value and the expected rack position value in the changed mode, compares the difference with a preset threshold value, and re-determines the control limit value.

In this case, the control limit value may be determined as one of the first control limit value and the second control limit value according to the result of re-determining the difference. However, it is not limited to this embodiment, and the determining operations may be implemented in various ways.

The one or more processors 620 may change the rack position control value according to the control limit value.

For example, the one or more processors 620 may set the expected rack position value as the rack position control value according to the control limit value.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

What is claimed is:

1. A vehicle control method comprising:
receiving sensed information generated by one or more sensors;
determining a mode change intention of a driver for changing a mode for driving a vehicle based on the sensed information of the one or more sensors;
setting a rack position control value for controlling a rack position using the sensed information of the one or more sensors in response to the mode change intention of the driver;
determining a control limit value by comparing a difference between the rack position control value set using the sensed information and a rack position value expected in the changed mode with a threshold value; and
changing the rack position control value based on the control limit value.

2. The vehicle control method of claim 1, wherein the sensed information includes at least one of a mode change signal for changing the mode for driving the vehicle, information related to a steering torque, and information related to a rack position.

3. The vehicle control method of claim 1, wherein the determining of the mode change intention of the driver comprises determining the mode change intention of the driver based on the mode change signal and the information related to the steering torque.

4. The vehicle control method of claim 3, wherein the determining of the mode change intention comprises determining that there is the mode change intention of the driver if the mode change signal is valid and the steering torque is smaller than or equal to a torque threshold value.

5. The vehicle control method of claim 1, wherein the setting of the rack position control value comprises setting the rack position control valve for the information related to the rack position included in the sensed information.

6. The vehicle control method of claim 1, wherein the determining of the control limit value comprises determining a first control limit value if the difference between the rack position control value set using the sensed information and the rack position value expected in the changed mode is smaller than or equal to a threshold value.

7. The vehicle control method of claim 6, wherein the determining of the control limit value comprises determining a second control limit value different from the first control limit value if the difference between the rack position control value set using the sensed information and the rack position value expected in the changed mode is greater than a threshold value.

8. The vehicle control method of claim 7, wherein the changing of the rack position control value comprises changing the rack position control value based on the second control limit value, wherein the second control limit value is lower than the first control limit value.

9. The vehicle control method of claim 8, further comprising:
re-determining the difference between the rack position control value set using the sensed information and the rack position value expected in the changed mode; and
re-determining the control limit value by comparing the re-determined difference between the rack position control value set using the sensed information and the rack position value expected in the changed mode with the threshold value.

10. The vehicle control method of claim 1, wherein the changing of the rack position control value comprises setting the rack position control value for the rack position value expected in the changed mode.

11. A vehicle control device comprising:
a memory configured to store instructions that are executable; and
one or more processors configured to execute the instructions to perform operations comprising:
receiving sensed information generated by one or more sensors;
determining a mode change intention of a driver for changing a mode for driving a vehicle based on the sensed information of the one or more sensors;
setting a rack position control value for controlling a rack position using the sensed information of the one or more sensors in response to the mode change intention of the driver;
determining a control limit value by comparing a difference between the rack position control value set using the sensed information and a rack position value expected in the changed mode with a threshold value; and
changing the rack position control value based on the control limit value.

12. The vehicle control device of claim 11, wherein the sensed information includes at least one of a mode change signal for changing the mode for driving the vehicle, information related to a steering torque, and information related to a rack position.

13. The vehicle control device of claim 11, wherein the one or more processors are configured to determine the mode change intention of the driver based on the mode change signal and the information related to the steering torque.

14. The vehicle control device of claim 13, wherein the one or more processors are configured to determine that there is the mode change intention of the driver if the mode change signal is valid and the steering torque is smaller than or equal to a torque threshold value.

15. The vehicle control device of claim 11, wherein the one or more processors are configured to set the rack position control valve for the information related to the rack position included in the sensed information.

16. The vehicle control device of claim 11, wherein the one or more processors are configured to determine a first control limit value if the difference between the rack position control value set using the sensed information and the rack position value expected in the changed mode is smaller than or equal to a threshold value.

17. The vehicle control device of claim 16, wherein the one or more processors are configured to determine a second control limit value different from the first control limit value if the difference between the rack position control value set using the sensed information and the rack position value expected in the changed mode is greater than a threshold value.

18. The vehicle control device of claim 17, wherein the one or more processors are configured to change the rack position control value based on the second control limit value, wherein the second control limit value is lower than the first control limit value.

19. The vehicle control device of claim 18, wherein one or more processors are configured to re-determine the difference between the rack position control value set using the sensed information and the rack position value expected in the changed mode, and re-determine the control limit value by comparing the re-determined difference between the rack position control value set using the sensed information and the rack position value expected in the changed mode with the threshold value.

20. The vehicle control device of claim 11, wherein the one or more processors are configured to set the rack position control value for the rack position value expected in the changed mode.
